(19) United States
(12) Patent Application Publication
(10) Pub. No.: US 2024/0376581 A1
(43) Pub. Date: Nov. 14, 2024

(54) PRECIPITATION HARDENING MARTENSITIC STAINLESS STEEL AND METHOD FOR PRODUCING THE SAME

(71) Applicant: Nippon Yakin Kogyo Co., Ltd., Tokyo (JP)

(72) Inventors: Xin JI, Kawasaki City (JP); Taiki MAEDA, Kawasaki City (JP); Fugao WEI, Kawasaki City (JP)

(73) Assignee: Nippon Yakin Kogyo Co., Ltd., Tokyo (JP)

(21) Appl. No.: 18/683,529

(22) PCT Filed: Aug. 15, 2022
(86) PCT No.: PCT/JP2022/030883

§ 371 Date: Feb. 14, 2024

(30) Foreign Application Priority Data
Aug. 19, 2021 (JP) 2021-134110

(51) Int. Cl. C22C 38/42; C21D 8/02; C22C 38/00; C22C 38/02; C22C 38/04; C22C 38/06; C22C 38/44; C22C 38/48; C22C 38/50

(52) U.S. Cl. CPC C22C 38/42; C21D 8/0226; C21D 8/0263; C22C 38/001; C22C 38/02; C22C 38/04; C22C 38/06; C22C 38/44; C22C 38/48; C22C 38/50

(57) ABSTRACT

A precipitation hardening martensitic stainless steel consists of in mass %, C: 0.01 to 0.07%, Si: 1.0 to 2.5%, Mn: 0.1 to 2.5%, P: not more than 0.04%, S: not more than 0.0020%, Ni: 4.0 to 10.0%, Cr: 11.0 to 17.0%, Mo: 0.1 to 1.50%, Cu: 0.30 to 6.0%, Al: 0.001 to 0.200%, N: 0.001 to 0.020%, Ti: 0.15 to 0.45%, Nb: 0.15 to 0.55%, and Fe and inevitable impurities as a remainder, and satisfies the following formula (1):

$$Ti + 30 \times N \leq 0.9 . \qquad ( 1 )$$

### TECHNICAL FIELD

The present invention relates to improvements in productivity of precipitation hardening martensitic stainless steel which is appropriate for uses in which high strength is required, such as for a steel belt, press plate, plate spring, gasket, or the like. Furthermore, the present invention is for compositions and for a method for production thereof, in which service life can be greatly increased in a case in which a steel belt is produced by employing an appropriate method for production.

### BACKGROUND ART

Since precipitation hardening martensitic stainless steel can easily be made very strong by performing aging treatment on a martensitic microstructure, it is widely used for steel belts, press plates, or the like, and SUS630 is one of the most notable among these steels. The steel is strengthened by precipitating an ε-Cu phase by aging heat treatment. Its final strength is about 1500 MPa, but this is still not sufficient to satisfy recent requirements for strength. In particular, there are requirements for large increases in service life for use for steel belts, and it is understood that service life increase corresponds to high strength, and various kinds of research have been performed.

For example, in Patent Documents 1 to 3, a martensitic stainless steel in which Ti and Si are added are proposed; however, there are many limitations on production, for example, cold rolling is necessary to obtain high strength. Furthermore, due to its composition and metallic microstructure, it is assumed that cracking may be expected to occur during production, and there are many limitations on slab production using high productivity continuous casting. It is understood that the technique has lower productivity compared to that for production of a common type of stainless steel.

Similarly, in Patent Document 4, a steel is disclosed which is based on a new strengthening mechanism in which Ti and Nb are complexed as a strengthening element. The steel has satisfactory strength; however, productivity is low, and in particular, it is known that there is a problem of slab cracking in continuous casting processing.

Furthermore, in Patent Document 5, a steel is proposed, in which Al is added to realize strengthening and to improve productivity. However, oxides due to Al are easily formed at a welding bead, and application to a use in which properties of a welded part are important, such as in a steel belt, is limited.

Many kinds of provisions have been suggested with respect to requirements for strengthening as mentioned above, and certain effects have been obtained. However, the current situation is that productivity has decreased, and therefore use of the production method has not become very common. Furthermore, if productivity is improved, on the other hand, another property may become worse. Thus, a steel which satisfies all of the requirements has not been conventionally realized.

The Patent Documents are as follows.

Patent Document 1: Japanese Unexamined Patent Application Publication No. 2017-155317

Patent Document 2: Japanese Unexamined Patent Application Publication No. 2002-173740

Patent Document 3: Japanese Unexamined Patent Application Publication No. Heisei 11 (1999)-256282

Patent Document 4: Japanese Patent Publication No. 6776467

Patent Document 5: Japanese Patent Publication No. 4870844

### SUMMARY OF INVENTION

With respect to the requirements for strengthening, various kinds of strengthening elements have been added to realize strengthening; however, this can lower productivity, and cost and delivery time are not yet at satisfactory levels. The current situation is that chemical compositions and production methods having better productivity are required. Therefore, an object of the present invention is to investigate chemical compositions and production process so as to provide precipitation hardening martensitic stainless steel having superior strength, and service life is increased, which is required for use as a steel belt, is accomplished.

The present invention was completed in view of the above circumstances, and the precipitation hardening martensitic stainless steel of the present invention consists of, in mass %, C: 0.01 to 0.07%, Si: 1.0 to 2.5%, Mn: 0.1 to 2.5%, P: not more than 0.04%, S: not more than 0.0020%, Ni: 4.0 to 10.0%, Cr: 11.0 to 17.0%, Mo: 0.1 to 1.50%, Cu: 0.30 to 6.0%, Al: 0.001 to 0.200%, N: 0.001 to 0.020%, Ti: 0.15 to 0.45%, Nb: 0.15 to 0.55%, and Fe and inevitable impurities as the remainder, and satisfies the following formula (1).

$$Ti + 30 \times N \leq 0.9 \qquad ( 1 )$$

In the precipitation hardening martensitic stainless steel of the present invention, it is desirable that Mscal. (° C.) defined by the formula (2) be in a range of 90 to 160° C., and δcal. (vol. %) defined by the formula (3) be in a range of 1.0 to 9.0%.

$$Mscal . ( ° C . ) = 1240.1 - 1301 ) \times ( C + N ) - 27.8 \times Si - 33.3 \times Mn - 61.1 \times Ni - 41.7 \times Cr - 44.3 \times Mo - 27.4 \times Cu + 24.2 \times Al + 18.1 \times Ti + 32.8 \times Nb \qquad ( 2 )$$

$$δ cal . ( vol . \% ) = 4.3 \times ( 1.3 \times Si + Cr + Mo + 2.2 \times Al + Ti + Nb ) - 3.9 \times ( 30 \times C + 30 \times N + Ni + 0.8 \times Mn + 0.3 \times Cu ) - 31.5 \qquad ( 3 )$$

In the precipitation hardening martensitic stainless steel of the present invention, it is desirable that the formula (4) be satisfied.

$$Nb + 13.3 \times C \leq 1.2 \qquad ( 4 )$$

Furthermore, the method for production of the precipitation hardening martensitic stainless steel of the present invention comprises steps of: producing a rectangular slab by a continuous casting method, forming the slab into a belt by hot rolling, and/or forming the slab or the belt into a certain plate thickness by cold rolling, if necessary, and performing solution heat treatment at 900 to 1150° C.

In the method for production of the precipitation hardening martensitic stainless steel of the present invention, it is desirable that when a rectangular slab is obtained by a continuous casting method, the hot-rolled steel belt or cold-rolled steel belt be obtained using the slab as a raw material and both edges in the width direction be removed so as to form a product, the removal of the width direction is minimized by setting the removed amount to 75 mm at most, and in this way, the outer side of a triple point at which casting microstructures grown from longer sides and shorter side intersect in a case in which it is seen from a cross section at the rectangular slab step, is contained as both ends of the product.

Furthermore, in the present invention, a wide steel belt produced by the above producing method is also provided, and it is desirable that the width be not less than 800 mm.

### BRIEF DESCRIPTION OF DRAWINGS

FIG. 1 is a graph showing effects of Ti and N amounts on occurrence of breaking on a steel belt.

FIG. 2 is a graph showing effects of C and Nb amounts on occurrence of cracking on a continuous casted slab.

FIG. 3 is a schematic diagram explaining a solidified microstructure on a cross section of a slab and on a rolled belt.

### EMBODIMENTS OF INVENTION

In order to accomplish strengthening, as shown in the Patent Documents, means are proposed as follows: (1) addition amount of elements which cause hardening is increased; and (2) another strengthening factor is added (for example, rearrangement by cold rolling is added); however, strengthening may cause decrease of ductility and embrittlement, and it is not always a good solution. Therefore, in order to clarify the relationship between achievement of strengthening and service life increase of a steel belt, the inventors have performed extensive research on causes of breaking of steel belts.

Target materials are a steel in which Ti and Nb are both added and which is strengthened by an ε-Cu phase and an Ni₁₆(Ti,Nb)₆Si₇ intermetallic compound (hereinafter referred to as the G phase) and is proposed by one of the inventors, and a steel such as SUS630. As a result of research, it became clear that breaking occurred from an edge part of a belt in most cases. It is recognized that the edge part is processed by a processing to be rounded and service life of the steel belt is affected by the design and processing accuracy thereof.

Furthermore, as a result of observation of broken surfaces in detail, it became clear that the morphology of breaking could be categorized into two categories. One of them was a fracturing from an origin point of a nonmetallic inclusion existing near the surface. The origin point was Ti nitrides having a size of about 15 μm, and a break at a surface looked like cracking being considered as having propagated relatively fast rather than having propagated slowly. It was considered that because martensitic stainless steels exhibited breaking morphology of brittleness originally, a large stress was imparted to the steel belt. It was suggested that a case in which a breaking origin was included inside has adverse effects even if strengthening was achieved, content of nitrogen should be limited if Ti was added, and use of elements other than Ti was desirable as strengthening elements.

The other morphology of breaking was a peculiar morphology which looked like cracking that propagated preferentially at a central part of the plate thickness, and it seemed an edge part might be an origin point, but this was not clear. Steels which exhibited this breaking morphology corresponded to steels in which width of an edge part had been removed so as to reduce size in a width direction due to cracking or damage of the width edge part during the production process. Although the cause was not clear, it could be assumed that improvement in productivity would be effective.

As a result of investigation of the steel belt as above, although strengthening seems to be effective, there are many other factors affecting service life other than the above factor, and the inventors considered that certain effects could be obtained by design of chemical compositions and the production process, and thus, the inventors determined to study improvement from these viewpoints.

### (a) Breaking Suppression of Ti Nitride Origin Point/Selection of Strengthening Elements

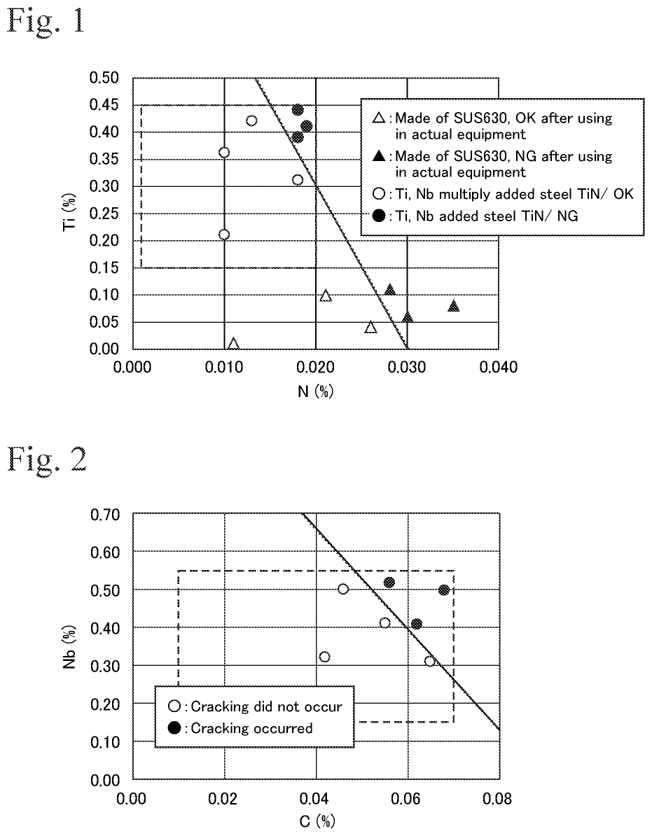

With respect to a sample of SUS630 in which Ti nitrides were found to be an origin point and a sample of the same kind steel of which service life was relatively long, compositions were analyzed. Ranges of each of the compositions of steel belts made of SUS630 investigated are shown in Table 1. Raw materials were charged and melted and alloy was produced. This was performed multiply with varying compositions in each charge. With respect to the multiple charges, FIG. 1 shows three charges evaluated being not good (shown by a black triangle) and three charges evaluated being good (shown by a white triangle) plotted according to amount of Ti and N. That is, there was a tendency to be worse as amounts of Ti and N increased. It should be noted that Ti is basically not added in SUS630, and it was considered to be contamination from scrap used as a raw material.

TABLE 1

| C | Si | Mn | Ni | Cr | Cu | Ti | Nb | N |
|---|---|---|---|---|---|---|---|---|
| 0.028~ | 0.41~ | 0.67~ | 4.2~ | 15.05~ | 3.33~ | 0~ | 0.18~ | 0.011~ |
| 0.033 | 0.46 | 0.75 | 4.5 | 16.19 | 3.41 | 0.11 | 0.21 | 0.035 |

Then, steels having Ti and Nb as strengthening elements in aging heat treatment were melted in a laboratory and were evaluated by regarding size of TiN of this as the equivalent circle diameter. Charging of raw materials and melting in the laboratory was performed at 20 kg per 1 charge using a high frequency melting furnace. As shown in Table 2, Ti and N amounts were varied in compositions of the Ti and Nb multiple addition steel. After casting, a columnar microstructure part being 20 mm from the surface was cut out, an embedded sample was prepared, mirror polishing was performed, an area of 20 mm×20 mm was observed at 400 times magnification, maximal TiN size was measured, and evaluation whether it was superior or inferior was performed comparing the results of the SUS630.

As a result, a large size TiN was observed similarly in a region including large amounts of Ti and N. This region was regarded being unacceptable (NG), and a border line was set based on the NG region together with the result of SUS630 so that the following formula (1) can be defined. By controlling Ti and N to satisfy this formula, generation of harmful TiN can be restrained even in steel with added Ti.

$$Ti + 30 \times N \leq 0.9 \qquad ( 1 )$$

TABLE 2

| C | Si | Mn | Ni | Cr | Cu | Ti | Nb | N |
|---|---|---|---|---|---|---|---|---|
| 0.015~ | 1.61~ | 0.9~ | 7.5~ | 14.1~ | 0.78~ | 0.21~ | 0.19~ | 0.010~ |
| 0.019 | 1.92 | 1.1 | 7.8 | 14.6 | 0.87 | 0.44 | 0.22 | 0.019 |

In a case in which steel is strengthened by a G phase, problems occur if Ti is the main element in the phase. Therefore, the inventors considered that the problems could be minimized if Nb was the main ingredient in strengthening, performed melting in the laboratory, and performed similar evaluation as above. The main compositions were the same as disclosed in Table 2, Ti and N were set to be 0.33% and 0.18%, respectively, and Nb was varied as 0.20%, 0.35% and 0.45%. As a result, it was confirmed that there was no change in TiN size if Nb amount was increased. That is, it became obvious that addition of Nb would be effective in a case in which addition amount of a strengthening element could be increased in order to provide further strengthening. Multiple addition of Ti and Nb is very effective for service life elongation.

### (b) Breaking Suppression With Peculiar Morphology

Next, the inventors researched the latter problems of breaking morphology. Size reduction in a width direction is a major issue from the viewpoint of production cost. Reasons for size reduction were (1) slab cracking due to cooling during continuous casting and (2) cracking due to hot processing. Then, with respect to a steel which is promising in solving breaking of a TiN origin point, the inventors tried to solve the problem. That is, cracking of (1) is prevented by controlling temperature at which martensitic transformation starts by the Mscal (° C.) formula, and cracking of (2) is prevented by controlling δ ferritic amount which affects hot workability by the δcal (%) formula. Since the coefficient of Ti was unknown, the coefficient was calculated preliminarily using laboratory melted material so as to employ it. As a result, cracking of (2) was improved to a level at which there was no problem; however, cracking of (1) could not be prevented completely.

The inventors researched the reason for that control was partially unsuccessful in a case in which Nb was added in spite of reliable effects being obtained in a case in which Al was added. There were two charges in which occurrence of cracking differed from each other in spite that the charges having Mscal value of the same extent. The structure of the cracking parts was observed, there was more NbC observed in the charge in which more cracking occurred. Furthermore, NbC was less in the topmost surface layer and was greater inside the slab, and NbC was obviously more uneven in the charge in which cracking occurred.

From the above results, it can be assumed as follows. That is, during continuous casting, precipitation of Nb carbides differs due to difference of cooling rates along the thickness direction and the width direction in a rectangular slab, and as a result, the condition of carbon, which greatly affects the starting point of martensitic transformation, differs, and local unevenness of martensitic transformation occurs, thereby causing cracking. The inventors considered this tendency was the same because cracking occurred in an area near a corner part of a longer edge side at which cooling rate easily varied.

Then, the continuous casted slab was produced and was tested as follows. This is one of the Examples explained below. As shown in FIG. 2, cracking was confirmed in high-Nb and high-C regions. It is difficult to cool a rectangular slab accurately and evenly during continuous casting, and evenness is maintained in a certain range. Therefore, it was considered that it would be difficult to reflect the influence of NbC precipitation by cooling in Mscal (° C.) in formula (2), and the inventors decided to achieve stabilization by excluding a case in which the amounts of Nb and C were large, which is expected to cause great changes. In order to set a border line from the above results, the following formula can be defined. Cracking in a slab can be prevented by controlling composition so as to satisfy this formula.

$$Nb + 13.3 \times C \leq 1.2 \qquad ( 4 )$$

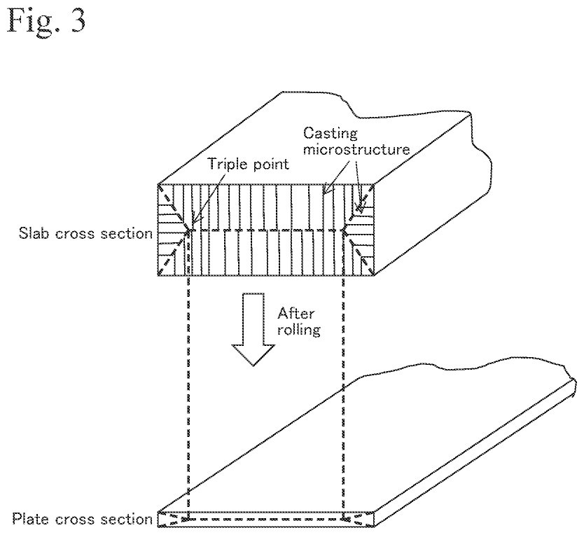

In a cross section of a rectangular slab produced by continuous casting, a metallic solidified microstructure consists of a short side structure and a long side structure. This is because cooling is done from two long-side surfaces and two short-side surfaces, and four structures grow from each of surfaces to the inner direction, as shown in FIG. 3. Therefore, if focusing on only one end part of a slab, three columnar solidified microstructures grow from long sides, that are the upper surface and lower surface of the width direction, and the short side, that is, the thickness direction. A triple point is formed at an interface of the three structures. A structure which is inside of the triple point and intersects at a central part of the thickness direction is called the final solidifying part. The final solidifying part is a part having inferior evenness of structure and is a part at which cracking of a central part of the plate thickness propagates preferentially. Therefore, if cracking occurs in a slab or in a hot rolled belt and the cracked part is cut off to remove it in the width direction, the final solidifying part appears at an end surface of the product, and the above-mentioned cracking may easily propagate. However, by countermeasures against slab cracking and cracking in hot rolling of the present invention, that is, minimizing amount of removal to an extent which remains outside of the triple point in a product, a minimal amount of the width direction can be cut, and as a result, cracking of this kind can be prevented.

Furthermore, there is almost no case in which a product includes an end part just as it was hot rolled. A slitting process in which the width direction is removed is always necessary. Since there are many kinds of belt widths, fitting to a belt width required, by devising a hot rolling method, for example, by employing broadside rolling in which width is increased by rolling in a width direction, a position for collecting a product can be more reliable. In addition, it was confirmed that it is effective by performing electromagnetic stirring during continuous casting processing so as to disperse and reduce the final solidifying part. In order to avoid a product containing coarse TiN, it is also effective to apply a longitudinal type continuous casting method so as to promote floating separation.

Next, reasons for limitations of each of the compositions are explained.

### C: 0.01 to 0.07%

C is an element stabilizing the austenitic phase, and an element to be controlled so as to restrain generation of the δ ferritic phase. It is an important element contributing strengthening of martensitic phase if contained, and exhibiting strength in the present invention. Therefore, its lower limit is set to be 0.01%. However, if contained excessively, it may cause the retained austenitic phase to increase, adversely decreasing strength. In addition, it may form carbides mainly with Nb, vary the martensitic transformation starting temperature, and cause slab cracking. Therefore, its upper limit is set to be 0.07%. It is desirably 0.02 to 0.06, and more desirably 0.03 to 0.05%.

### Si: 1.0 to 2.5%

Si is an element added for deoxidation, and in the present invention, it is an important element required to obtain strength, having a function precipitating the G phase by aging heat treatment. Addition of not less than 1.0% is required to obtain these effects, if added excessively, the & ferritic phase may increase so as to deteriorate hot workability, and furthermore, formation of the TiN cluster may be promoted so as to cause a situation in which controlling is difficult. Therefore, the upper limit is set to be 2.5%. It is desirably 1.2 to 2.0%, and more desirably 1.3 to 1.9%.

### Mn: 0.1 to 2.5%

Since Mn is an element stabilizing the austenitic phase and has an effect of restraining generation of the & ferritic phase, it is necessary to add not less than 0.1%. However, the retained austenitic phase may increase, thereby deteriorating strength if contained excessively. Furthermore, MnS may be formed and corrosion resistance may be deteriorated. Therefore, the upper limit is set to be 2.5%. It is desirably 0.5 to 2.0% and more desirably 0.8 to 1.7%.

P: Not more than 0.04%

P is an element which is inevitably a contaminant in steel, and it may segregate at the crystal grain boundary, be concentrated at a final solidifying part during continuous casting and welding, promote solidification cracking, and furthermore, cause deterioration of hot workability. Therefore, it is desirable to reduce it as much as possible. However, production cost may be increased if an attempt is made to reduce it extremely, and the upper limit is set to be 0.04%. It is desirably 0.030% and more desirably 0.025%.

S: Not more than 0.0020%

S is an element which is inevitably a contaminant in steel, similar to P, and it is desirable to reduce it as much as possible since it may combine with Mn so as to form inclusions (MnS) and to deteriorate corrosion resistance. Furthermore, since it may segregate at a grain boundary so as to reduce hot workability, it is necessary to reduce it from this viewpoint. Therefore, the upper limit is set to be 0.0020%. It is desirably not more than 0.0015%, and more desirably not more than 0.0010%.

### Ni: 4.0 to 10.0%

Ni is an element which stabilizes the austenitic phase, and it has an effect of restraining generation of the 8 ferritic phase. Furthermore, it is one of the important elements in the present invention in which the G phase is formed by aging heat treatment so as to contribute to strengthening. It is necessary to add not less than 4.0% in order to obtain these effects. However, if added excessively, the retained austenitic phase may be increased and reduce strength. Therefore, the upper limit is set to be 10.0%. It is desirably 6.0 to 9.0%, and more desirably 6.5 to 8.5%.

### Cr: 11.0 to 17.0%

Cr is a necessary element in order to maintain corrosion resistance, and it is necessary to be at least 11.0%. However, if added excessively, generation of the δ ferritic phase may be promoted and deteriorate hot workability. Therefore, the upper limit is set to be 17.0%. It is desirably 12.0 to 16.0%, and more desirably 13.0 to 15.0%.

### Mo: 0.1 to 1.50%

Mo is a necessary element in order to maintain corrosion resistance, it is necessary to add at least 0.1%. However, if added excessively, generation of the & ferritic phase may be promoted and deteriorate hot workability. Therefore, the upper limit is set to be 1.50%. It is desirably 0.6 to 1.20%, and more desirably 0.7 to 1.00%.

### Cu: 0.30 to 6.0%

Cu is an element which stabilizes the austenitic phase, it has an effect to restrain generation of the δ ferritic phase. Furthermore, it is one of the important elements in the present invention in which the Cu phase is formed by aging heat treatment so as to contribute to strengthening, and it is necessary to add at least 0.30%. However, if added excessively, the retained austenitic phase may be increased and deteriorate hot workability. Therefore, the upper limit is set to be 6.0%. It is desirably 0.40 to 4.0%, and more desirably 0.50 to 1.5%.

### Al: 0.001 to 0.200%

Al is an element which is added for deoxidation, and it is a necessary element which makes Nb and Ti be reliably contained, which are easily oxidized and exhibit inferior yield ratio of addition in molten metal. It is the only element which heightens martensitic transformation starting temperature, and a useful element which can be used for controlling of the Ms point. Therefore, it is necessary to add not less than 0.001%. However, if added excessively, the & ferritic phase may be increased and hot workability may be deteriorated. Therefore, the upper limit is set to be 0.200%. It is desirably 0.002 to 0.170%, and more desirably 0.002 to 0.140%.

### N: 0.001 to 0.020%

N is an element which stabilizes the austenitic phase, and it is an element which should be controlled in order to restrain generation of the δ ferritic phase. It is an important element which contributes to strengthening of the martensitic phase and exhibits strength in the present invention by containing it. Therefore, the lower limit is set to be 0.001%. However, if contained excessively, retained austenitic phase may be increased, and on the other hand, strength may be deteriorated. Furthermore, it may mainly form nitrides with Ti, and be a breaking origin point of a steel belt. Furthermore, it may change the martensitic transformation starting temperature, and cause slab cracking. Therefore, the upper limit is set to be 0.020%. It is desirably 0.002 to 0.015%, and more desirably 0.003 to 0.010%

### Ti: 0.15 to 0.45%

Ti is an important element which forms the G phase with Si, Ni and Nb, and contributes to strengthening by aging heat treatment. To obtain these effects, it is necessary to add not less than 0.15%. However, if added excessively, the & ferritic phase may be increased, and hot workability may be deteriorated. Furthermore, it is more desirable for the addition amount to be smaller if possible, because it may form compounds with nitrogen and cause breaking origin points. Alternatively, other adverse effects may occur, that is, martensitic transformation starting temperature may be changed and slab cracking may occur. Therefore, the upper limit is set to be 0.45%. It is desirably 0.20 to 0.40%, and more desirably 0.25 to 0.35%.

### Nb: 0.15 to 0.55%

Nb is an important element which forms the G phase with Si, Ni and Nb and contributes to strengthening by aging heat treatment. To obtain the effects, it is necessary to add not less than 0.15%. However, if added excessively, the δ ferritic phase may be increased and may deteriorate hot workability. Furthermore, other adverse effects may occur, that is, martensitic transformation starting temperature may be changed and slab cracking may occur by forming compositions with carbon. Therefore, the upper limit is set to be 0.55%. It is desirably 0.20 to 0.50%, and more desirably 0.25 to 0.45%.

Ti+30×N≥0.9

This is a formula indicating amounts of Ti and N in order to prevent service life of a steel belt from being extremely short by TiN, and this was found in the present invention. According to the Ti amount contained, the permitted N amount can be determined.
(1)′ is desirable and (1)″ is more desirable.

$$Ti + 30 \times N \leq 0.85 \qquad {( 1 )}^{′}$$

$$Ti + 30 \times N \leq 0.8 \qquad {( 1 )}^{″}$$

$$Mscal . ( ° C . ) 90 to 160 ° C .$$

$$Mscal . ( ° C . ) = 1240.1 - 1300 \times ( C + N ) - 27.8 \times Si - 33.3 \times Mn - 61.1 \times Ni - 41.7 \times Cr - 44.3 \times Mo - 27.4 \times Cu + 24.2 \times Al + 18.1 \times Ti + 32.8 \times Nb$$

Mscal. is a calculation formula in which martensitic transformation starting point (Ms point) is envisaged based on compositions, and in which the term Ti is added so that the formula can be employed in the present invention. An element symbol in the formula indicates content (mass %) of the corresponding composition. In a case in which this value is less than 90° C., the retained austenitic phase may remain in large amount, and a predetermined strength may not be obtained after aging heat treatment. On the other hand, in a case in which the value is greater than 160° C., transformation to martensite may occur during cooling in a continuous casting process and surface cracking may occur. Therefore, it is necessary to control it within a range of 90 to 160° C. It is desirably 95 to 140° C., and more desirably 100 to 125° C. δcal. (vol. %) 1.0 to 9.0%

$$δ cal . ( vol . \% ) = 4.3 \times ( 1.3 \times Si + Cr + Mo + 2.2 \times Al + Ti + Nb ) - 3.9 \times ( 30 \times C + 30 \times N + Ni + 0.8 \times Mn + 0.3 \times Cu ) - 31.5$$

δcal. is a calculation formula which estimates volume % of the δ ferritic phase generated in a slab produced by continuous casting, and in which the term Ti is added so as to be employed in the present invention. An element symbol in the formula indicates content (mass %) of the corresponding composition. In a case in which this value is less than 1.0%, frequency of occurrence of solidification cracking in a continuous casted slab may be increased, adverse effects by P and S may become pronounced, and cracking during hot rolling may occur. On the other hand, in a case in which the value is greater than 9.0%, hot workability of a slab may be deteriorated and cracking may occur. Therefore, it is necessary to control it within a range of 1.0 to 9.0%. It is desirably 2.0 to 7.0%, and more desirably 2.5 to 6.5%.

$$Nb + 13.3 \times C \leq 1.2$$

This is a formula which indicates Nb and C amounts in order to prevent slab cracking occurring by NbC formed unevenly during continuous casting process, which is found in the present invention. According to Nb amount contained, admissible C amount can be determined. (4)′ is desirable and (4)″ is more desirable.

$$Nb + 13.3 \times C \leq 1.1 \qquad {( 4 )}^{′}$$

$$Nb + 13.3 \times C \leq 1. \qquad {( 4 )}^{″}$$

Remainder other than the compositions mentioned above of the precipitation hardening martensitic stainless steel of the present invention consists of Fe and inevitable impurities. Here, the inevitable impurity is a composition which is inevitably contaminated for various reasons during industrial stainless steel production, and it means a composition admitted to be contained in a range not adversely affecting on action and effect of the present invention.

Next, a method for producing the precipitation hardening martensitic stainless steel of the present invention is explained. Although the method for production of an alloy of the present invention is not limited in particular, it is desirable to produce it by the following method. First, raw materials such as Ni alloy scrap, iron scrap, stainless steel scrap, ferrochromium, ferronickel, pure nickel, and metallic chromium are melted in an electric furnace. After that, in an AOD furnace or a VOD furnace, together with decarburizing and refining by blowing oxygen gas and argon gas, calcined lime, fluorite, Al, Si and the like are put so as to perform desulfurizing and deoxidizing processes. It is desirable that slag compositions in the process be controlled of the CaO—Al₂O₃—SiO₂—MgO—F type. Furthermore, in order to efficiently promote desulfurizing simultaneously, it is desirable that the slag satisfy CaO/Al₂O₃≥2, and CaO/SiO₂≥3. In addition, it is desirable that refractory material of the AOD furnace and VOD furnace be magnesia-chrome or dolomite. After refining by the AOD furnace or the like, compositions are adjusted by LF process, temperature is adjusted, a rectangular slab is produced by continuous casting, the slab is hot-rolled, the slab is cold-rolled if necessary, and solution heat treatment is performed at a predetermined plate thickness so as to obtain a product.

It is necessary to perform solution heat treatment at 900 to 1150° C. The reason is that in a case in which it is performed at less than 900° C., re-solid solution of precipitation strengthening element, carbide, or the like, may not be sufficient, strength may not be increased sufficiently by aging treatment performed thereafter, or corrosion resistance may be deteriorated. On the other hand, in a case in which heat treatment is performed at greater than 1150° C., crystal grain size may be coarse, toughness may be extremely deteriorated, and service life as a steel belt may not be adequate. Therefore, it is necessary to perform heat treatment in a range of 900 to 1150° C. It is desirably 950 to 1100° C., and more desirably 980 to 1075° C. Furthermore, it is desirable to keep retention time not less than 15 seconds. The reason is that soaking of heat of the entirety of a product is ensured, and minimizing unevenness of partial strength and toughness. The time should be appropriately set in view of plate thickness. It is desirably not less than 30 seconds, and more desirably not less than 1 minute.

### EXAMPLES

Hereinafter, the present invention is explained further in detail with reference to Examples. It should be noted that the present invention is not limited to these Examples unless departing from the spirit thereof. Raw materials such as iron scrap, stainless steel scrap, ferrochromium and the like were melted in an electric furnace of 60 t (Samples Nos. 1 to 30). After that, oxygen and argon were blown to perform decarburization and refining in AOD process. After that, calcined lime, fluorite, Al, Si were added to perform desulfurization and deoxidation. After that, casting was performed by a continuous casting apparatus of a vertical type so as to obtain a slab. The width was 1550 mm, and chemical compositions of each sample are shown in Table 3.

TABLE 3

| | | C | Si | Mn | P | S | Ni | Cr |
|---|---|---|---|---|---|---|---|---|
| Examples | 1 | 0.011 | 1.01 | 0.11 | 0.030 | 0.0018 | 9.2 | 13.4 |
| | 2 | 0.068 | 1.00 | 2.21 | 0.030 | 0.0018 | 4.6 | 16.9 |
| | 3 | 0.015 | 2.10 | 2.45 | 0.036 | 0.0016 | 4.5 | 11.8 |
| | 4 | 0.012 | 2.42 | 0.45 | 0.032 | 0.0016 | 7.8 | 11.2 |
| | 5 | 0.022 | 1.96 | 0.52 | 0.028 | 0.0012 | 8.8 | 12.9 |
| | 6 | 0.028 | 1.25 | 0.65 | 0.026 | 0.0013 | 6.2 | 12.8 |
| | 7 | 0.055 | 1.00 | 2.45 | 0.016 | 0.0015 | 4.4 | 15.3 |
| | 8 | 0.034 | 1.65 | 1.54 | 0.023 | 0.0005 | 6.7 | 13.2 |
| | 9 | 0.045 | 1.45 | 0.92 | 0.015 | 0.0012 | 6.5 | 13.1 |
| | 10 | 0.042 | 1.82 | 0.98 | 0.018 | 0.0008 | 7.6 | 13.6 |
| | 11 | 0.048 | 1.90 | 0.80 | 0.023 | 0.0006 | 7.3 | 12.5 |
| | 12 | 0.035 | 1.12 | 0.55 | 0.006 | 0.0005 | 6.5 | 13.6 |
| | 13 | 0.031 | 1.30 | 0.82 | 0.028 | 0.0005 | 6.8 | 14.0 |
| | 14 | 0.045 | 1.52 | 0.95 | 0.015 | 0.0008 | 6.8 | 13.0 |
| | 15 | 0.032 | 1.33 | 1.55 | 0.011 | 0.0005 | 5.7 | 14.1 |
| | 16 | 0.030 | 1.42 | 1.02 | 0.012 | 0.0004 | 6.6 | 13.4 |
| | 17 | 0.035 | 1.32 | 0.88 | 0.015 | 0.0003 | 6.5 | 13.5 |
| | 18 | 0.031 | 1.53 | 0.95 | 0.022 | 0.0008 | 7.1 | 13.0 |
| | 19 | 0.042 | 1.32 | 1.25 | 0.009 | 0.0006 | 6.2 | 13.5 |
| | 20 | 0.054 | 1.05 | 2.45 | 0.015 | 0.0006 | 4.8 | 14.8 |
| | 21 | 0.034 | 1.77 | 1.34 | 0.012 | 0.0004 | 6.1 | 12.4 |
| | 22 | 0.068 | 1.65 | 1.01 | 0.012 | 0.0004 | 6.5 | 13.2 |
| | 23 | 0.062 | 1.58 | 1.35 | 0.018 | 0.0008 | 4.6 | 13.4 |
| Comparative | 24 | 0.038 | 1.42 | 1.35 | 0.011 | 0.0005 | 5.2 | 14.0 |
| Examples | 25 | 0.042 | 1.35 | 0.89 | 0.021 | 0.0008 | 6.7 | 12.8 |
| | 26 | 0.034 | 1.65 | 1.01 | 0.012 | 0.0004 | 6.5 | 13.2 |
| | 27 | 0.045 | (2.82) | 0.80 | 0.021 | 0.0004 | 6.5 | 12.5 |
| | 28 | 0.015 | 2.10 | 2.45 | 0.036 | 0.0016 | 4.5 | 11.8 |
| | 29 | 0.042 | 1.35 | 0.89 | 0.021 | 0.0008 | 6.2 | 12.8 |
| | 30 | (0.073) | 1.65 | 1.01 | 0.012 | 0.0004 | 6.5 | 13.2 |

| | | Mo | Cu | Al | N | Ti | Nb |
|---|---|---|---|---|---|---|---|
| Examples | 1 | 0.12 | 0.31 | 0.100 | 0.001 | 0.44 | 0.51 |
| | 2 | 0.13 | 1.36 | 0.182 | 0.014 | 0.18 | 0.20 |
| | 3 | 1.40 | 5.52 | 0.001 | 0.001 | 0.16 | 0.15 |
| | 4 | 1.48 | 0.38 | 0.007 | 0.016 | 0.41 | 0.52 |
| | 5 | 0.62 | 0.42 | 0.045 | 0.002 | 0.22 | 0.22 |
| | 6 | 1.11 | 3.56 | 0.024 | 0.015 | 0.36 | 0.46 |
| | 7 | 0.25 | 1.52 | 0.032 | 0.013 | 0.24 | 0.24 |
| | 8 | 0.85 | 0.55 | 0.006 | 0.004 | 0.35 | 0.44 |
| | 9 | 0.76 | 1.44 | 0.143 | 0.006 | 0.34 | 0.32 |
| | 10 | 0.88 | 0.52 | 0.014 | 0.006 | 0.28 | 0.42 |
| | 11 | 0.85 | 0.52 | 0.056 | 0.004 | 0.37 | 0.45 |
| | 12 | 0.92 | 0.62 | 0.006 | 0.006 | 0.33 | 0.27 |
| | 13 | 0.88 | 0.58 | 0.011 | 0.008 | 0.25 | 0.25 |
| | 14 | 0.72 | 1.01 | 0.081 | 0.006 | 0.26 | 0.26 |
| | 15 | 0.71 | 1.40 | 0.008 | 0.019 | 0.32 | 0.27 |
| | 16 | 0.91 | 1.12 | 0.006 | 0.003 | 0.31 | 0.27 |
| | 17 | 0.77 | 1.30 | 0.016 | 0.008 | 0.32 | 0.42 |
| | 18 | 0.81 | 0.54 | 0.133 | 0.010 | 0.34 | 0.30 |
| | 19 | 0.85 | 0.65 | 0.100 | 0.005 | 0.25 | 0.28 |
| | 20 | 0.85 | 1.25 | 0.111 | 0.015 | 0.34 | 0.25 |
| | 21 | 0.85 | 0.85 | 0.009 | 0.008 | 0.31 | 0.54 |
| | 22 | 0.85 | 0.85 | 0.009 | 0.008 | 0.31 | 0.38 |
| | 23 | 0.92 | 1.25 | 0.090 | 0.0006 | 0.28 | 0.54 |
| Comparative | 24 | 0.70 | 1.35 | 0.008 | (0.025) | 0.15 | 0.29 |
| Examples | 25 | 0.75 | 1.20 | 0.012 | 0.005 | (0.50) | 0.25 |
| | 26 | 0.85 | 0.85 | 0.009 | 0.008 | 0.31 | (0.85) |
| | 27 | 0.47 | 0.75 | 0.006 | 0.005 | 0.27 | 0.25 |
| | 28 | 1.40 | (6.13) | 0.001 | 0.001 | 0.16 | 0.15 |
| | 29 | 0.75 | 1.20 | 0.012 | 0.018 | 0.45 | 0.25 |
| | 30 | 0.85 | 0.85 | 0.009 | 0.008 | 0.31 | 0.19 |

| | | Ti + | | | Nb + | |
|---|---|---|---|---|---|---|
| | | 30 [symbol] N | δ | Ms | 13.3 [symbol] C | Remarks |
| Examples | 1 | 0.47 | 0.2 | 87.3 | 0.7 | |
| | 2 | 0.80 | 10.4 | 59.5 | 1.1 | |
| | 3 | 0.19 | 4.8 | 106.9 | 0.3 | |
| | 4 | 0.89 | 5.1 | 126.5 | 0.7 | |
| | 5 | 0.28 | 0.8 | 34.2 | 0.5 | |
| | 6 | 0.81 | 2.8 | 99.0 | 0.8 | |
| | 7 | 0.63 | 8.8 | 95.7 | 1.0 | |
| | 8 | 0.47 | 5.6 | 101.9 | 0.9 | |
| | 9 | 0.58 | 4.3 | 103.8 | 0.9 | |
| | 10 | 0.46 | 5.2 | 28.9 | 1.0 | |
| | 11 | 0.49 | 2.9 | 96.7 | 1.1 | |
| | 12 | 0.51 | 7.2 | 130.3 | 0.7 | |
| | 13 | 0.49 | 8.9 | 103.1 | 0.7 | |
| | 14 | 0.44 | 2.4 | 98.0 | 0.9 | |
| | 15 | 0.89 | 7.6 | 94.0 | 0.7 | |
| | 16 | 0.40 | 6.4 | 105.3 | 0.7 | |
| | 17 | 0.56 | 5.9 | 108.3 | 0.9 | |
| | 18 | 0.64 | 4.4 | 105.3 | 0.7 | |
| | 19 | 0.40 | 6.5 | 119.6 | 0.8 | |
| | 20 | 0.79 | 9.4 | 74.3 | 1.0 | |
| | 21 | 0.55 | 5.2 | 164.5 | 1.0 | |
| | 22 | 0.55 | 2.8 | 71.6 | 1.3 | |
| | 23 | 0.30 | 12.2 | 179.4 | 1.4 | |
| Comparative | 24 | 0.90 | 8.2 | 116.6 | 0.8 | N is out of range |
| Examples | 25 | 0.65 | 1.8 | 120.1 | 0.8 | Ti is out of range |
| | 26 | 0.55 | 7.9 | 124.5 | 1.1 | Nb is out of range |
| | 27 | 0.42 | 7.8 | 123.5 | 0.8 | Si is out of range |
| | 28 | 0.19 | 4.1 | 80.2 | 0.3 | Cu is out of range |
| | 29 | (0.99) | 2.1 | 132.9 | 0.8 | Only formula (1) |
| | | | | | | is out of range |
| | 30 | 0.55 | 1.4 | 58.8 | 1.2 | C is out of range |

[symbol]

indicates data missing or illegible when filed

It should be noted that among these elements, chemical compositions other than C, S, and N were analyzed by X-ray fluorescence analysis. N was analyzed by an inert gas-impulse heating melting method, and C and S were analyzed by a combustion in an oxygen gas flow-infrared absorption method.

After that, the slab was heated at 900 to 1250° C. and was hot-rolled so as to obtain a hot-rolled coil of plate thickness of 6.5 mm. Subsequently, solution heat treatment of this hot-rolled coil was performed, the coil was processed by acid pickling and further, cold-rolled, and the final solution heat treatment and acid pickling process were performed, so as to obtain a cold-rolled coil of plate thickness of 3.5 mm. The solution heat treatment was performed under conditions in which the coil was held at 1050° C. for 2.5 minutes and then cooled by water. In a case in which cracking occurred in a belt and size reduction in the width direction was required, the size reduction was performed in a condition immediately after hot rolling. In a case in which size reduction in the width direction is required due to surface defects, the size reduction was performed by slitting a hot-rolled belt after solution heat treatment, or a cold-rolled belt.

Qualities of samples were confirmed as follows. In addition, results of evaluation are shown in Table 4.

### Observation of Microstructure/TiN

A sample was collected from a hot-rolled belt in which solution heat treatment plus acid pickling were performed and evaluated. Location of collection was a portion of 70 mm from a width end part of the hot-rolled belt corresponding to a corner part, that is, an edge part where there is a high risk of occurrence of cracking in a case in which it is processed into steel belt. The embedded sample was prepared so as to observe the plate surface, and mirror polishing was performed by the required minimum polishing. A region of 25 mm×25 mm was observed by a microscope of magnification 200 times, so as to find the largest size TIN. An observed sample in which maximal TiN size was not more than 8 μm was evaluated as superior (A), a sample with more than 8 μm and not more than 10 μm was evaluated as good (B), a sample with more than 10 μm and not more than 15 μm was evaluated as satisfactory (C), and a sample of more than 15 μm was evaluated as inferior (D).

### Slab Cracking

Appearance of a slab after continuous casting was confirmed visually on both surfaces. The slab end surface and a range of about 200 mm from the end surface were observed especially carefully. As a result, a slab on which there was no cracking observed was evaluated as superior (A), a slab on which cracking was at a level possible to be removed by a grinder, length thereof was not more than 20 mm and number thereof was not more than 2 per 10 m was evaluated as good (B), a slab on which cracking was of a similar level, length thereof was not more than 70 mm and number thereof was not more than 5 per 10 m was evaluated as satisfactory (C), and a slab on which cracking was extensive and at a level considered to require surface processing and cutting off in a width direction was evaluated as inferior (D).

### Hot Workability

A side surface of a coil on which hot rolling was performed was observed visually so as to confirm occurrence of cracking at an edge surface. A coil on which there was no cracking at all was evaluated as superior (A), a coil on which there was cracking confirmed on the edge surface, but the length thereof was not more than 2 mm and at a level being no problem in production was evaluated as good (B), a coil on which there was similar cracking confirmed on the edge surface but the length thereof was not more than 5 mm and at a level being no problem in production was evaluated as satisfactory (C), and a coil on which there was cracking confirmed having a length greater than 5 mm and considered requiring cutting off in a width direction was evaluated as inferior (D),

### Product Width

How much product width could be finally maintained, and which location the product width was at if converted into continuous casted slab width, are important points as a steel belt material. Therefore, with respect to a hot-rolled belt to which annealing-acid pickling were performed, width of a product possible to be collected was measured and compared. Width may be varied, and it may be widened in most cases by hot rolling, and the influence thereof is small. Therefore, a sample in which a length to be removed from the width after hot rolling was not more than 30 mm at one side was evaluated as superior (A), a sample in which a length to be removed was not more than 50 mm and more than 30 mm was evaluated as good (B), a sample in which a length to be removed was not more than 75 mm and more than 50 mm was evaluated as satisfactory (C), and a sample in which a length to be removed was more than 75 mm which was the basis mentioned above, was evaluated as inferior (D).

TABLE 4

| | | TiN | Slab cracking | Hot workability | Slab width |
|---|---|---|---|---|---|
| Examples | 1 | A | C | B | C |
| | 2 | B | B | C | C |
| | 3 | A | A | A | A |
| | 4 | C | B | B | B |
| | 5 | A | C | B | C |
| | 6 | C | B | B | B |
| | 7 | B | A | B | A |
| | 8 | A | B | B | B |
| | 9 | B | B | A | A |
| | 10 | A | B | B | B |
| | 11 | A | B | A | A |
| | 12 | B | B | B | B |
| | 13 | A | A | B | B |
| | 14 | A | B | A | A |
| | 15 | B | A | B | A |
| | 16 | A | A | B | A |
| | 17 | B | B | B | A |
| | 18 | B | B | A | A |
| | 19 | A | A | B | A |
| | 20 | C | B | C | C |
| | 21 | B | C | B | C |
| | 22 | B | C | A | C |
| | 23 | B | C | C | C |
| Comparative | 24 | D | C | C | C |
| Examples | 25 | D | C | C | C |
| | 26 | B | D | — | — |
| | 27 | D | A | C | C |
| | 28 | A | B | D | D |
| | 29 | D | C | B | B |
| | 30 | B | D | — | — |

Samples Nos. 1 to 23 satisfied requirements of the present invention, and therefore, there was no problem in each of evaluations. Therefore, it became clear that a product having a width of 800 mm could be obtained from a rectangular slab having a width less than about 1000 mm, for example, and although depending on compositions selected, production from a slab having a width less than 900 mm was also possible and its yield could be improved.

Among the samples, amount of the δ ferritic phase was out of the range of 1.0 to 9.0% in Nos. 1, 2, 5, 20 and 23, slab width was not unacceptable, but was not superior because slab cracking occurred or hot workability deteriorated. In addition, the Ms point was more than 160° C. in Nos. 21 and 23, slab surface cracking occurred after continuous casting, and size reduction of slab width was performed. On the other hand, Ms point was less than 90° C. in Nos. 2, 5, 10, 20 and 22, and high strength, being a basic requirement, was difficult to be maintained. Furthermore, (Nb+13.3×C) value was more than 1.2 in Nos. 22 and 23, slab cracking occurred in a continuous casting process, although there was no problem in production, size reduction of slab width was required.

On the other hand, N amount and Ti amount were out of the range of the present invention in No. 24 and No. 25, respectively, therefore, large amounts of coarse TiN was included in each case. Although hot workability was not unacceptable, it not at a superior level.

Nb amount was out of the range of the present invention in No. 26, cracking which was at a level difficult to remove occurred in the slab, and therefore, hot rolling of this steel was not performed.

Si amount was out of the range of the present invention in No. 27, and therefore, TiN was larger than a size expected based on compositions and could not be controlled. It was assumed that one reason for this was that viscosity of the melt metal was too low.

The Cu amount was out of the range of the present invention in No. 28, and therefore, hot workability was inferior, and large cracking occurred.

The formula which controls TiN was out of the range of the present invention in No. 29, and therefore, TiN was coarse.

C amount was out of range of the present invention in No. 30, and therefore, cracking occurred in the slab. According to this, the inventors considered that hot rolling was impossible, and hot rolling was not performed.

1. A precipitation hardening martensitic stainless steel consisting of:
in mass %, C: 0.01 to 0.07%, Si: 1.0 to 2.5%, Mn: 0.1 to 2.5%, P: not more than 0.04%, S: not more than 0.0020%, Ni: 4.0 to 10.0%, Cr: 11.0 to 17.0%, Mo: 0.1 to 1.50%, Cu: 0.30 to 6.0%, Al: 0.001 to 0.200%, N: 0.001 to 0.020%, Ti: 0.15 to 0.45%, Nb: 0.15 to 0.55%, and Fe and inevitable impurities as a remainder, and
satisfying the following formula (1)
$$Ti + 30 \times N \leq 0.9 . \qquad ( 1 )$$

2. The precipitation hardening martensitic stainless steel according to claim 1, wherein Mscal. (° C.) defined by the formula (2) is in a range of 90 to 160° C., and δcal. (vol. %) defined by the formula (3) is in a range of 1.0 to 9.0%;
$$Mscal . ( ° C . ) = 1240.1 - 1300 \times ( C + N ) - 27.8 \times Si - 33.3 \times Mn - 61.1 \times Ni - 41.7 \times Cr - 44.3 \times Mo - 27.4 \times Cu + 24.2 \times Al + 18.1 \times Ti + 32.8 \times Nb ; \qquad ( 2 )$$
$$and$$
$$δ cal . ( vol . \% ) = 4.3 \times ( 1.3 \times Si + Cr + Mo + 2.2 \times Al + Ti + Nb ) - 3.9 \times ( 30 \times C + 30 \times N + Ni + 0.8 \times Mn + 0.3 \times Cu ) - 31.5 . \qquad ( 3 )$$

3. The precipitation hardening martensitic stainless steel according to claim 1, wherein the formula (4) is satisfied:
$$Nb + 13.3 \times C \leq 1.2 . \qquad ( 4 )$$

4. A method for production of the precipitation hardening martensitic stainless steel according to claim 1, comprising the steps of:
producing a rectangular slab by a continuous casting method;
forming the slab into a belt by hot rolling, and/or forming the slab or the belt into a certain plate thickness by cold rolling, if necessary; and
performing solution heat treatment at 900 to 1150° C.

5. The method for production of the precipitation hardening martensitic stainless steel according to claim 4, wherein when the rectangular slab is obtained by the continuous casting method, the hot-rolled steel belt or cold-rolled steel belt is obtained using the slab as a raw material and both edges of width direction are removed so as to form a product, the removal of the width direction is minimized by setting the removed amount to 75 mm at most, and in this way, the outer side of a triple point at which casting structures grown from longer sides and shorter side intersect in a case in which it is seen from a cross section in the rectangular slab step, are contained as both ends of the product.

6. The precipitation hardening martensitic stainless steel according to claim 2, wherein the formula (4) is satisfied:
$$Nb + 13.3 \times C \leq 1.2 . \qquad ( 4 )$$

7. A method for production of the precipitation hardening martensitic stainless steel according to claim 2, comprising the steps of:
producing a rectangular slab by a continuous casting method;
forming the slab into a belt by hot rolling, and/or forming the slab or the belt into a certain plate thickness by cold rolling, if necessary; and
performing solution heat treatment at 900 to 1150° C.

8. A method for production of the precipitation hardening martensitic stainless steel according to claim 3, comprising the steps of:
producing a rectangular slab by a continuous casting method;
forming the slab into a belt by hot rolling, and/or forming the slab or the belt into a certain plate thickness by cold rolling, if necessary; and
performing solution heat treatment at 900 to 1150° C.

9. A method for production of the precipitation hardening martensitic stainless steel according to claim 6, comprising the steps of:
producing a rectangular slab by a continuous casting method;
forming the slab into a belt by hot rolling, and/or forming the slab or the belt into a certain plate thickness by cold rolling, if necessary; and
performing solution heat treatment at 900 to 1150° C.

10. The method for production of the precipitation hardening martensitic stainless steel according to claim 7, wherein when the rectangular slab is obtained by the continuous casting method, the hot-rolled steel belt or cold-rolled steel belt is obtained using the slab as a raw material and both edges of width direction are removed so as to form a product, the removal of the width direction is minimized by setting the removed amount to 75 mm at most, and in this way, the outer side of a triple point at which casting structures grown from longer sides and shorter side intersect in a case in which it is seen from a cross section in the rectangular slab step, are contained as both ends of the product.

11. The method for production of the precipitation hardening martensitic stainless steel according to claim 8, wherein when the rectangular slab is obtained by the continuous casting method, the hot-rolled steel belt or cold-rolled steel belt is obtained using the slab as a raw material and both edges of width direction are removed so as to form a product, the removal of the width direction is minimized by setting the removed amount to 75 mm at most, and in this way, the outer side of a triple point at which casting structures grown from longer sides and shorter side intersect in a case in which it is seen from a cross section in the rectangular slab step, are contained as both ends of the product.

12. The method for production of the precipitation hardening martensitic stainless steel according to claim 9, wherein when the rectangular slab is obtained by the continuous casting method, the hot-rolled steel belt or cold-rolled steel belt is obtained using the slab as a raw material and both edges of width direction are removed so as to form a product, the removal of the width direction is minimized by setting the removed amount to 75 mm at most, and in this way, the outer side of a triple point at which casting structures grown from longer sides and shorter side intersect in a case in which it is seen from a cross section in the rectangular slab step, are contained as both ends of the product.
